(19) United States
(12) Patent Application Publication
(10) Pub. No.: US 2001/0054340 A1
(43) Pub. Date: Dec. 27, 2001

(54) METHOD OF CUTTING MAGNETIC RECORDING MEDIUM AND CUTTING APPARATUS

(76) Inventor: SHINGO FUJIKATA, KANAGAWA (JP)

Correspondence Address: SUGHRUE MION ZINN MACPEAK & SEAS PLLC, 2100 PENNSYLVANIA AVENUE NW, WASHINGTON, DC, 20037

(21) Appl. No.: 09/441,212

(22) Filed: Nov. 16, 1999

(30) Foreign Application Priority Data
Nov. 16, 1998 (JP) HEI. 10-325163

(51) Int. Cl. B26D 7/08

(52) U.S. Cl. 83/14; 242/353; 226/118.3

(57) ABSTRACT

A method of cutting a magnetic recording medium comprising the steps of conveying a web by rollers to guide the web to a cutting blade; and cutting the web by the cutting blade in the lengthwise direction of the web so that magnetic recording mediums are formed, wherein a dynamic unbalance of at least a roller immediately before the cutting blade is made to be 20 g or smaller, and the roller guides the web to the cutting blade.

### BACKGROUND OF THE INVENTION

1. Field of the Invention

The present invention relates to a method of cutting a magnetic recording medium and a cutting apparatus, and more particularly to a method of cutting a magnetic recording medium and a cutting apparatus which are capable of forming a magnetic recording medium free from a considerably large quantity of meandering of side ends of the cut magnetic recording medium.

2. Description of the Related Art

Hitherto, magnetic recording mediums, such as audio tapes, video tapes and computer tapes, have been manufactured such that a wide web incorporating a non-magnetic support member, on which a magnetic layer containing ferromagnetic particles, is formed is conveyed by rollers. Thus, the magnetic layer is subjected to an orienting process, a drying and solidifying process and surface treatment. Finally, the web is cut into the lengthwise direction of the web.

After the magnetic layer of the wide web has been subjected to the surface treatment, the web is temporarily wound up. Then, the wound web is set to a cutting apparatus. FIG. 5 shows a state in which the web has been set to the cutting apparatus. In the cutting apparatus 20, a web 50 is fed from a feeding portion 21 so as to be conveyed on a nip roller 22 and a plurality of guide rollers 23 and guided to a cutting blade 25. The nip roller 22 cuts off a tension which is exerted on the web at a position upstream of the nip roller and also a tension which is exerted on the web at a position downstream of the nip roller. A suction drum is sometimes employed as a substitute for the nip roller 22.

The web 50 guided to the cutting blade 25 is cut into the lengthwise direction by the cutting blade so that a plurality of magnetic recording mediums each having a small width are formed. The magnetic recording mediums 51 each having the small width are again conveyed on the guide roller 24 so as to be wound around individual winding rolls 26.

In general, the magnetic recording medium 51 formed by cutting the web 50 has the side ends which meander as shown in FIG. 6. Distance S from the side end of the magnetic recording medium in the form of a required straight shape and indicated with an alternate long and two short dashes line shown in FIG. 6 to the side end of the meandering magnetic recording medium 51 indicated with a solid line is called an “amount of meandering” in this specification.

When a magnetic recording medium having a large amount S of meandering is wound around a tape reel to constitute a magnetic-tape cassette, such as a video tape, the head of a reproducing apparatus is deviated from a correct track of the magnetic tape when a reproducing operation is performed. As a result, the reproduction output is sometimes undesirably reduced. In particular, a high-density magnetic recording tape, such as a video tape for commercial use, is a magnetic tape on which an influence of the change in the reproduction output is exerted considerably. Therefore, reduction in the amount S of meandering, for example, reduction to 9 mm or smaller, is required.

Hitherto, magnetic recording mediums encountered the amount S of meandering larger than an allowable range are sorted as defective products. The magnetic recording mediums having the large amount S of meandering are scraped. The foregoing sorting operation, however, is a very complicated operation. Moreover, scrapping of the defective product inhibits reduction in the manufacturing cost of the magnetic recording mediums. Hence it follows that a cutting method and a cutting apparatus with which magnetic recording mediums free from a considerably large amount of meandering can be formed.

The inventor of the present invention have performed a variety of attempts to prevent meandering of the magnetic recording medium 51 which is considered to be caused from a multiplicity of causes. For example, an attempt has been performed to prevent change in the tension which is exerted on the web 50. Other attempts have been performed to prevent meandering of a wide web in the widthwise direction of the same when the web is guided to the cutting blade 25 and to reduce deviation of the guide roller 23 and the static unbalance of the same. Meandering of the magnetic recording medium 51 cannot be prevented.

### SUMMARY OF THE INVENTION

The inventor of the present invention has furthermore energetically performed investigations. As a result, employment of rollers each exhibiting a satisfactory dynamic balance, that is, a restrained dynamic unbalance, to serve as the rollers (the guide roller and the nip roller) adjacent to the cutting blade of the cutting apparatus enables meandering of the magnetic recording medium to be prevented. The “dynamic balance” is a state of distribution of masses of the rotor which cause vibrating force or motion to be produced owing to centrifugal force.

Accordingly, an object of the present invention is to prevent meandering of a magnetic recording medium.

To achieve this, according to the present invention, there is provided a method of cutting a magnetic recording medium comprising the steps of: conveying a web by rollers to guide the web to a cutting blade; and cutting the web by the cutting blade in the lengthwise direction of the web so that magnetic recording mediums are formed, wherein a dynamic unbalance of at least a roller immediately before the cutting blade is made to be 20 g or smaller, and the roller guides the web to the cutting blade.

According to another aspect of the present invention, there is provided an apparatus for cutting a magnetic recording medium comprising:

rollers for conveying a web to a cutting blade so that the web is cut in the lengthwise direction of the web by the cutting blade so as to form magnetic recording mediums, wherein a dynamic unbalance of at least a roller immediately before the cutting blade is made to be 20 g or smaller.

In the present invention, it is preferable that the dynamic unbalance made to be 20 g or smaller is made to be 17 g or smaller. The “dynamic unbalance” is measured by a dynamic-unbalance testing machine such that the dynamic unbalance (hereinafter called a “one-side unbalance”) of each of ends A and B of a roller 1 shown in FIG. 2 is measured. The dynamic unbalance is the sum of the one-side unbalance at the end A and that at the end B.

In addition to the improvement in the dynamic unbalance of the roller immediately before the cutting blade, improvement in dynamic unbalances of rollers disposed adjacent to the cutting blade at positions upstream of the cutting blade and downstream of the same enables meandering of the magnetic recording medium to furthermore satisfactorily be prevented. It is preferable that the dynamic unbalance of, for example, a roller disposed between a roller, such as a nip roller for cutting off the tension of the web and the cutting blade is made to be 20 g or smaller.

The magnetic recording medium formed by the cutting operation performed as described above exhibits a very small amount of meandering. Thus, a defective product can be prevented. As a result, an operation for sorting defective products can be omitted. In addition, no defective product, which must be scrapped, is produced. Hence it follows that the manufacturing cost of the magnetic recording medium can be reduced.

Other objects, features and advantages of the invention will be evident from the following detailed description of the preferred embodiments described in conjunction with the attached drawings.

### BRIEF DESCRIPTION OF THE DRAWINGS

FIG. 1 is a diagram showing an embodiment of the present invention;

FIG. 2 is a diagram showing positions at which the dynamic unbalance of a roller is measured;

FIG. 3 is a graph for evaluating the embodiment of the present invention;

FIG. 4 is a graph for evaluating the embodiment of the present invention;

FIG. 5 is a graph for evaluating the embodiment of the present invention;

FIG. 6 is a graph for evaluating the embodiment of the present invention;

FIG. 7 is a diagram showing a conventional cutting apparatus; and

FIG. 8 is a diagram showing meandering of a magnetic tape.

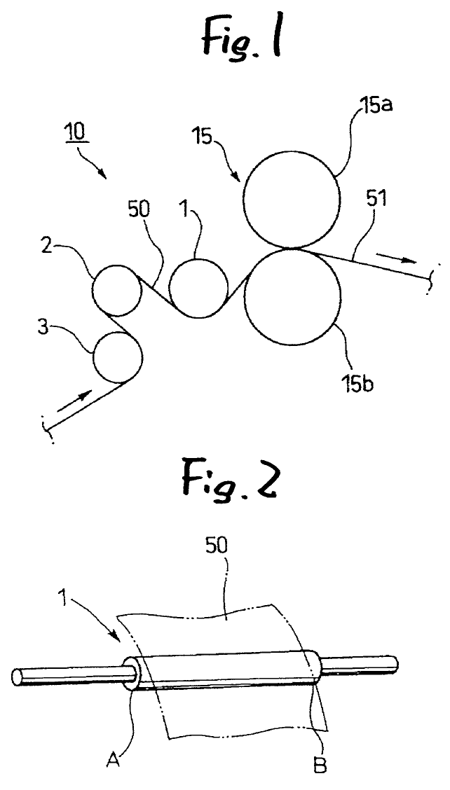

### DESCRIPTION OF THE PREFERRED EMBODIMENTS

FIG. 1 shows a cutting apparatus 10 according to an embodiment of the present invention. A wide web 50 is allowed to run along three guide rollers 1, 2 and 3 so as to be guided to a cutting blade 15 incorporating an upper blade 15a and a lower blade 15b. The guide roller 1 has a diameter of 100 mm, while the diameter of each of the guide rollers 2 and 3 is 80 mm. The dynamic unbalance of at least the guide roller 1 is made to be 20 g or smaller.

When conveyance of a web 50 has been started by a drive roller (not shown), the web 50 is conveyed on the guide rollers 1, 2 and 3 without any slip. The web 50 is sequentially cut in the lengthwise direction of the web 50 by the cutting blade 15 so that elongated magnetic recording mediums 51 are formed.

### EXAMPLES

Examples of the present invention will now be described to confirm the effect of the present invention.

Examples and a comparative example were structured such that the cutting apparatus 10 shown in FIG. 1 incorporated rollers having dynamic unbalances shown in Table 1 and combined with one another as the guide rollers 1, 2 and 3.

Then, each video tape for commercial use, which is a high-density magnetic recording tape, was cut. Also results of measurement of maximum amounts of meandering of the video tapes cut by the structures according to the embodiments and the comparative example were shown in Table 1.

Moreover, the frequency of meandering of each of the video tapes cut by the structures according to the examples and the comparative example was analyzed. Thus, the intensities (intensities of analyzed frequencies) of the components of meandering corresponding to the circumferences of the roller 1 having a diameter of 100 mm and the guide rollers 2 and 3 each having a diameter of 80 mm were measured. Also results of the foregoing measurement were shown in Table 1. The “intensity of the analyzed frequency” will be described later.

TABLE 1

| | | | | Maximum | Intensity of | |
|---|---|---|---|---|---|---|
| | | | | Amount of | Analyzed | |
| | Dyanamic Unbalance (g) | | | Meander- | Frequency (mV) | |
| | Roller | Roller | Roller | ing | Roller | Roller |
| | 1 | 2 | 3 | (μm) | 1 | 2, 3 |
| Example 1 | 5.3 | 17.0 | 7.6 | 7.3 | 1.3 | 1.4 |
| Example 2 | 3.1 | 3.8 | 3.2 | 6.2 | 1.0 | 0.8 |
| Comparative | 27.5 | 19.3 | 21.8 | 9.7 | 1.6 | 1.9 |
| Example | | | | | | |

The dynamic unbalance testing machine was a dynamic unbalance testing machine FH414G manufactured by Akashi.

The video tape was as follows.

Initially, 100 parts by weight of ferromagnetic alloy powder (composition: Fe was 94%, Zn was 4% and Ni was 2%, coercive force (Hc) : 1500 Oe and crystal size: 200 angstrom) were pulverized for 10 minutes by an open kneader. Then, a variety of binders were added so as to be kneaded and dispersed. Thus, magnetic coating material was prepared. Then, the magnetic coating material was applied to the surface of a polyethylene terephthalate support member having a thickness of 10 mm by using a reverse roll such that the dry thickness of the coating material was 2.5 mm. Then, a 3000 gauss magnet was used in a state in which the magnetic coating material was not dried to orient the magnetic field of the support member. After the support member was dried, a calender process was performed. Then, the obtained tape was cut by the cutting apparatus 10 structured as shown in FIG. 1 such that the width of the tape was ½ inch.

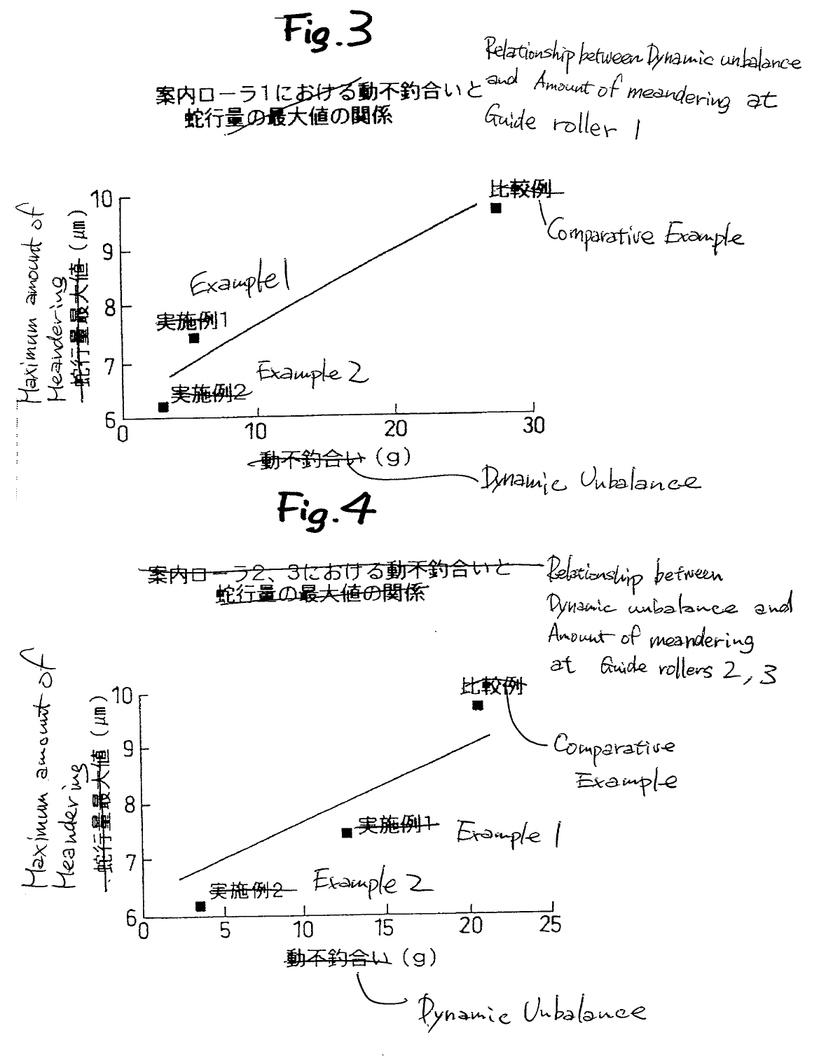

FIG. 3 shows the relationship between the dynamic unbalance and the amount of meandering of the roller 1 having the diameter of 100 mm according to each example and the comparative example. FIG. 4 shows the relationship between an average dynamic unbalances and amount of meandering of each of the guide rollers 2 and 3 each having the diameter of 80 mm and according to each example and the comparative example.

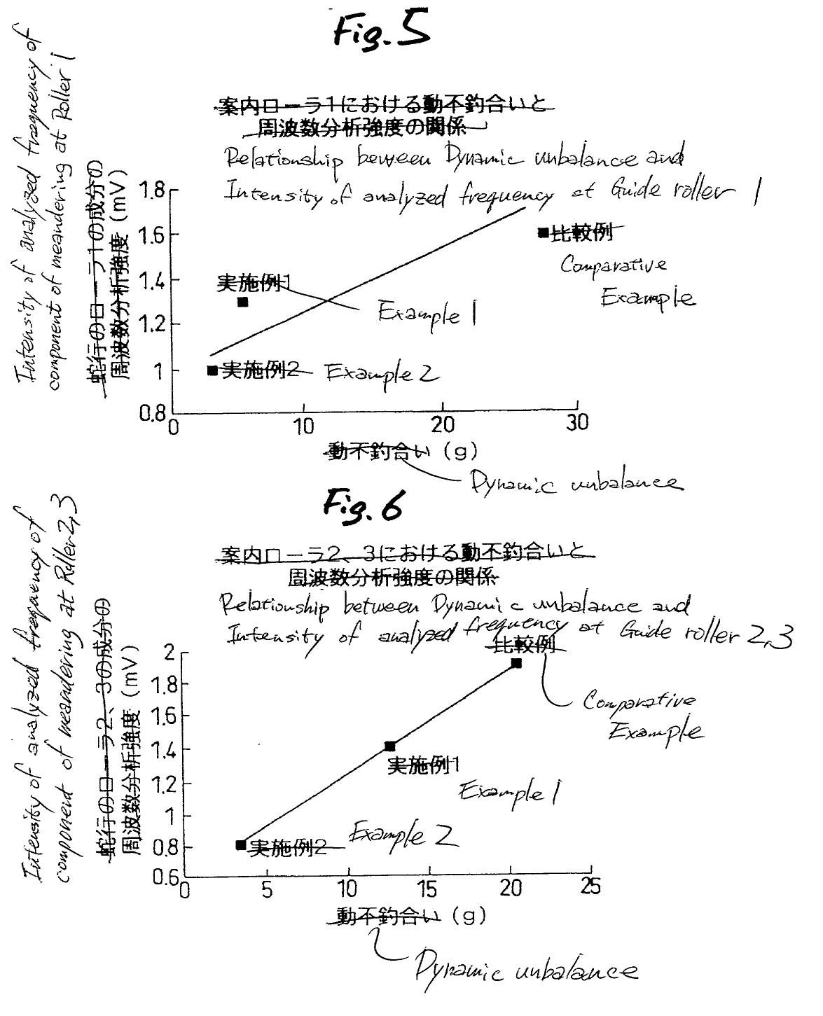

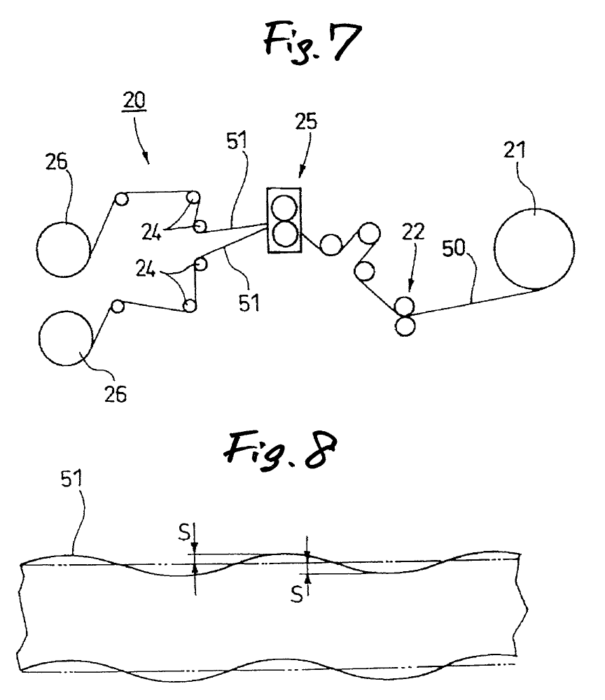

FIG. 5 shows the relationship between the dynamic unbalance of the roller 1 having the diameter of 100 mm and the intensity of the analyzed frequency of meandering of the cut video tape at the roller 1 realized in each example and the comparative example. FIG. 6 shows the relationship between the dynamic unbalance of the rollers 2 and 3 each having the diameter of 80 mm and the intensity of the analyzed frequency of meandering of the cut video tape at the guide roller 2 realized in each example and the comparative example.

When the frequency of meandering of the cut video tape is performed, a variety of frequency components can be detected. The “intensity of analyzed frequency” is the intensity of a frequency component of a frequency among complicated frequencies of meandering which corresponds to the circumference of the guide roller 1 having the diameter of 100 mm and the intensity of the frequency component of the frequency corresponding to the circumference of each of the guide rollers 2 and 3 each having the diameter of 80 mm. When the intensity of the analyzed frequency is used, meandering caused from the guide roller 1 and meandering caused from the guide rollers 2 and 3 can be detected.

As shown in FIGS. 3 and 4, as the dynamic unbalance is reduced in the sequential order as the comparative example, Example 1 and Example 2, the maximum amount of meandering can reliably be reduced.

As shown in FIGS. 5 and 6, as the dynamic unbalance is reduced in the sequential order as the comparative example, Example 1 and Example 2, the intensity of the analyzed frequency can reliably be reduced similarly to the maximum amount of meandering shown in FIGS. 3 and 4. Each of the guide rollers 2 and 3 each having the diameter of 80 mm and shown in FIG. 6 has a substantially parallel relationship between the intensity of the analyzed frequency and the maximum amount of meandering.

As can be understood from FIGS. 3 to 6, the present invention has a significant effect. As can be understood from FIGS. 3 to 4, reduction in the dynamic unbalance of the guide roller 1 which is the roller adjacent to the cutting blade and having the diameter of 100 mm and the dynamic unbalance of each of the guide rollers 2 and 3 each having the diameter of 80 mm enable the amount of meandering to reliably be reduced.

As can be understood from FIGS. 5 and 6, the ratio of meandering caused from the dynamic unbalance of each roller among meandering of the video tape caused from the guide rollers 1, 2 and 3 is considerably high. As shown in FIG. 6, the dynamic unbalance of each of the guide rollers 2 and 3 each having the diameter of 80 mm and the intensity of the analyzed frequency have a substantially proportional relationship. Therefore, the dynamic unbalance of the guide rollers 2 and 3 having a large lapping angle exerts on great influence on meandering of the video tape.

The video tape for commercial use is sometimes required to reduce the maximum amount of meandering to be 9 mm or smaller. When the cutting apparatus 10 shown in FIG. 1 is operated to cut the video tape, a fact can be understood from FIGS. 3 and 4 that the dynamic unbalance of each of the guide rollers 1, 2 and 3 must be 20 g or smaller.

As described above, according to the present invention, a magnetic recording medium with which the amount of meandering can be reduced can reliably be manufactured. Therefore, an operation for sorting defective products encountered a great amount of meandering can be omitted. Since a defective product which must be scrapped is not produced, the manufacturing cost of the magnetic recording medium can be reduced.

According to the present invention, a reference tape exhibiting a small amount of meandering and arranged to adjust a reproducing apparatus can easily be manufactured.

Although the invention has been described in its preferred form and structure with a certain degree of particularity, it is understood that the present disclosure of the preferred form can be changed in the details of construction and in the combination and arrangement of parts without departing from the spirit and the scope of the invention as hereinafter claimed.

What is claimed is:

1. A method of cutting a magnetic recording medium comprising the steps of:
conveying a web by rollers to guide the web to a cutting blade; and
cutting the web by said cutting blade in the lengthwise direction of the web so that magnetic recording mediums are formed,
wherein a dynamic unbalance of at least a roller immediately before said cutting blade is made to be 20 g or smaller, and said roller guides the web to said cutting blade.

2. The cutting method according to claim 1, wherein the dynamic unbalance of at least the roller immediately before said cutting blade is made to be 17 g or smaller.

3. An apparatus for cutting a magnetic recording medium comprising:
rollers for conveying a web to a cutting blade so that the web is cut in the lengthwise direction of the web by said cutting blade so as to form magnetic recording mediums, wherein a dynamic unbalance of at least a roller immediately before said cutting blade is made to be 20 g or smaller.

4. The cutting apparatus according to claim 3, wherein the dynamic unbalance of at least the roller immediately before said cutting blade is made to be 17 g or smaller.
